(19) United States
(12) Patent Application Publication
(10) Pub. No.: US 2002/0028340 A1
(43) Pub. Date: Mar. 7, 2002

(54) Soft transparent polyolefin resin sheet and method for producing the same

(76) Inventors: Atsushi Fujii, Sodegaura-shi (JP); Tohru Yukumoto, Sodegaura-shi (JP); Kenichi Fujiwara, Tokyo (JP)

Correspondence Address: FLYNN, THIEL, BOUTELL & TANIS, P.C., 2026 Rambling Road, Kalamazoo, MI, 49008-1699, US

(21) Appl. No.: 09/880,440

(22) Filed: Jun. 13, 2001

Related U.S. Application Data
(63) Continuation-in-part of application No. 08/954,957, filed on Oct. 21, 1997, now abandoned.

(30) Foreign Application Priority Data
Oct. 22, 1996 (JP) 8-279380
Nov. 29, 1996 (JP) 8-319281

(51) Int. Cl. B32B 27/08

(52) U.S. Cl. 428/516; 428/520; 428/141

(57) ABSTRACT

A soft transparent polyolefin resin sheet according to the present invention is characterized by including the following properties (a) to (c): (a) a modulus of elasticity ranges from 20 MPa to 1,000 MPa; (b) an average length of a foreign substance that has a different refractive index from a non-crystalline resin composition occupying the most volume fraction is less than 10 μm, and the number of foreign substances in any section of the sheet is less than 500 foreign substances/mm²; and (c) a surface-roughness Ra of at least one of faces of the sheet is less than 0.2 μm. The soft transparent polyolefin resin sheet may have a multilayered structure, in which at least one of outer faces of the multilayered structures can be made of a hard polypropylene type resin.

This application is a continuation-in-part from application Ser. No. 08/954 957, filed Oct. 21, 1997.

### BACKGROUND OF THE INVENTION

1. Field of the Invention

This invention relates to a soft transparent polyolefin resin sheet and a method for producing the same. The fabricated sheet is used for packaging food, medicines, clothing and so on. Moreover, it can be used for a carrying case, stationery (e.g., a colorful pen case, a case with a fastener), a decorative sheet (used for, e.g., building materials, furniture), a greenhouse cover for agriculture, a case for eyewash, a case for CD-ROM, and so on.

2. Description of the Related Art

A polyvinyl chloride sheet has been generally used as a resin sheet (or film) having flexibility and heat resistance and outstanding in strength. The polyvinyl chloride (PVC) sheet, however, is given due consideration to the environment so that a monomer or a plasticizing agent containing poison is bled out during use, or hydrogen chloride or dioxine containing poison is produced in an incinerating process.

For the environment, the use of, for example, a polyethylene type or a polypropylene type sheet or film is proposed.

Instances of the polypropylene type sheet or film are shown with, for example, a polypropylene type film using a low-stereoregular polypropylene as the basis (Japanese Patent Laid-open No. Hei7-171849), and a laminated polypropylene type film of a polypropylene layer, a polypropylene-ethylene-butene-1 copolymer layer and a polypropylene layer (Japanese Patent Laid-open No. Hei6-218892).

The polyethylene type sheet has lower transparency, a shine and heat resistance and less body than the polyvinyl chloride sheet.

The polypropylene type sheet is superior to PVC as to the low-temperature heat-sealability and the brittle temperature, is virtually parallel with PVC as to mechanical properties such as rigidity and strength, and is inferior to PVC as to a shine and transparency such as gloss and haze.

A sheet made of polyolefin type resin has environmental friendliness as compared with the polyvinyl chloride sheet, but, on the other hand, it has the difficulty of fusing or fusion cut by means of high-frequency heating for reasons of a small dissipation loss.

The disadvantages in the high-frequency heating can be somewhat rectified by a resin sheet that is fabricated by mixing a polyolefin type resin and an ethylene-vinyl acetate copolymer resin, however, the sheet that is obtained through a conventional touch roll sheet forming method using a cooling roller is inferior in transparency.

### SUMMARY OF THE INVENTION

A soft transparent polyolefin resin sheet according to a first aspect of the present invention is characterized by including the following properties (a) to (c), the soft transparent polyolefin resin sheet having a multilayered structure where at least one surface layer is made of a hard polypropylene type resin and has a layer made of a soft resin:

(a) A modulus of elasticity (modulus under tension, modulus in tension) ranges from 20 MPa to 1,000 MPa.

When the modulus of elasticity is smaller than 20 MPa, the sheet has a low degree of body, resulting in the sheet having little value as a practical matter. When the modulus of elasticity is larger than 1,000 MPa, the sheet is harder and the handling qualities are inferior, so that the sheet is inapplicable to the use required. The preferred modulus of elasticity ranges from 50 MPa to 800 MPa.

(b) An average length of a foreign substance that has a refractive index different from a non-crystalline resin composition occupying the most volume fraction is less than 10 μm, and the number of foreign substances in any section of the sheet is less than 500 foreign substances/mm².

A principal factor in loss of transparency in the sheet is the scattering of incident light caused by the foreign substances. When the average length of the foreign substance is less than 10 μm and the number of foreign substances in any section of the face of the sheet is less than 500 foreign substances/mm², the scattering of light caused by the foreign substances can be decreased by a large amount, thereby avoiding the decrease of the transparency of the sheet.

The direction of the section of the face can be selectively determined, for example, a vertical section or a horizontal section with respect to the front face or the back face of the sheet.

The average length is a mean value of the longest and shortest selected sections of the foreign substance, for example, as in the diameter of a sphere.

The reality of the foreign substance is, for example, a crystalline phase included in the same resin as the aforementioned non-crystalline resin phase, a resin differing from the aforementioned non-crystalline resin phase, and an organic material or an inorganic material (such as calcium carbonate, talc) excepting the resin.

The length and the number of foreign substances can be inspected by the following means.

Where the foreign substance is a transparent body having a different refractive index from that of a matrix resin, the foreign substance can be inspected with a phase-contrast microscope through which contrast can be obtained. Additionally, the size can be measured by an small-angle light-scattering method.

Where the foreign substance is the crystalline phase, the foreign substance can be inspected with a polarizing microscope for reasons of optical anisotropy in a coherent configuration of a molecular chain in general.

Where the foreign substance has a molecular structure completely differing from that of a matrix resin, the foreign substance may be inspected with a scanning electron microscope or a transmission electron microscope.

(c) A surface-roughness Ra of at least one of faces of the sheet is less than 0.2 μm.

Another principal factor in loss of transparency in the sheet is reflections of the incident light by the surface of the sheet as well as the scattering of light caused by the foreign substance. More specifically, the proportion that the light reflects is increased by relationship with an angle of incident light when the sheet has asperities on the surface, thereby producing the irregular reflection. The asperities on the surface have a profound effect on the shine. When the surface-roughness is expressed as an average roughness at the center line Ra in quantity, he surface-roughness is defined to be less than 0.2 μm, thereby avoiding the irregular reflection or the decrease of shine. The preferable surface-roughness is less than 0.1 μm, more preferably, less than 0.05 μm.

The surface-roughness can be moderated by a method, such as a polishing, coating or scrubbing of the surface of the sheet.

Since the soft polyolefin resin sheet has a surface layer made of hard polypropylene type resin at least on one side thereof and a layer made of soft transparent polyolefin resin, blocking of the sheet can be prevented.

Specifically, since the same soft transparent polyolefin resin layers are superposed in an ordinary soft transparent polyolefin resin sheet, blocking is likely to be caused in winding up the sheet. On the other hand, since at least one of the surface layers is made of the hard polypropylene type resin, slidability on the hard resin layer surface can be improved, thereby preventing blocking.

The surface layer is made of a hard polypropylene type resin in order to increase the hardness and to increase a mar-proof property. In addition, the objectives are to improve chemical resistance and transferability as in carbon-copies, printing or the like, and to avoid bleed-out of a soft resin component as a middle layer.

Since the sheet has both of the hard and soft layers, freeze resistance of the sheet can be improved. Specifically, when the sheet is made solely of hard resin layers, flexibility and strength can be lost at lower temperatures. However, by laminating the soft transparent polyolefin resin layer, the flexibility and strength of the sheet is not lost at, for instance, a lower temperature of −30° C.

Incidentally, the sheet of the present invention can be a film that is relatively thinner.

The multilayered structure of the soft transparent polyolefin resin sheet may be a double-layered structure where the hard resin layer and soft transparent polyolefin resin layer are laminated.

Such a laminated sheet can obtain an advantage for preventing blocking on account of the hard resin layer and the heat sealing property obtained by the soft transparent polyolefin resin layer. Further, the hard resin layer is provided on the heated side during a sealing step. Accordingly, the sheet can be conveniently used for secondary processing into bags and clear files.

The multi-layered structure may have at least three layers including both surface layers and an intermediate layer, both of the surface layers being made of hard polypropylene resin, the intermediate layer being made of soft transparent polyolefin resin layer.

Accordingly, the advantages of the present sheet are prevention of blocking, anti-abrasion, heat resistance and chemical resistance etc. which can be more sufficiently exerted.

In the soft transparent polyolefin resin sheet having the multilayered structure, the preferably containing proportion of a soft transparent polyolefin resin layer is more than 10 wt %. The multilayered structure is formed by, for example, co-extruding.

“Soft” is defined as the modulus of elasticity of the sheet being less than 1,000 MPa. The preferred value is less than 800 MPa, more preferably, less than 600 MPa.

In the present invention, it is preferable that the layer ratio of the hard polypropylene resin layer is 50% or less of the entire sheet.

When the layer ratio of the hard resin layer exceeds 50%, rigidity of the entire sheet is increased and the advantage of the soft resin according to the combination of the hard and soft resin layers cannot be sufficiently exerted.

It is advisable that the surface layer of the soft transparent polyolefin resin sheet having the multilayered structure is resin selected from homo-polypropylene, an ethylene-propylene random copolymer (ethylene content ranging from 0.1 wt % to 10 wt %), and an ethylene-butene-propylene random copolymer (ethylene and butene content ranging from 0.1 wt % to 10 wt %).

The modulus of elasticity of the hard polypropylene type resin is 500 MPa or more, preferably 550 MPa or more, more preferably 600 MPa or more. The hard polypropylene type resin is selected so that the modulus of elasticity thereof becomes greater than the modulus of elasticity of the soft resin in accordance with the usage of the soft transparent polyolefin resin sheet considering the layer ratio, etc.

In the soft transparent polyolefin resin sheet, it is desirable that the soft transparent polyolefin resin sheet is formed by a low-stereoregular polypropylene type resin having a ratio of mmmm (a value of PI) ranging from 50% to 90% in a pentad ratio measured by using ¹³C-NMR with respect to stereoregularity of homo-polypropylene.

The aforementioned mmmm (0000) or (1111) is an isotactic pentad, “m” shows an isotactic yard, “0”, “1” show a configuration of an individual monomeric unit along a polymer chain, “0” shows any one of configurations, and “1” shows the opposite configuration.

The value of PI (Pentad Isotacticity) is an isotactic ratio in a pentad unit in a polypropylene molecular chain. A measuring method of the isotactic ratio is reported in “Macromolecules 6925” (1973).

When the value of PI is less than 50%, the heat resistance and the strength are decreased. When it exceeds 90%, the resin is harder, thereby rendering it unfit for the intended use as the soft sheet.

The low-stereoregular polypropylene type resin relating to the present invention is produced by the single step gas phase polymerization or the single slurry polymerization (Japanese Patent Laid-open No. Hei3-14851, Japanese Patent Laid-open No. Hei6-263934).

It is advisable that the value of rrrr/(1-mmmm) of the low-stereoregular polypropylene type resin ranges from 15% to 50%.

The rrrr is the state of syndiotacticity. The rrrr/(1-mmmm) of less than 15% renders the resin harder and unfit for the intended use as the soft sheet. The rrrr/(1-mmmm) of more than 50% causes the heat resistance and the strength to decrease.

It is advisable that the low-stereoregular polypropylene type resin consists of a boiled heptane insulable polypropylene type resin (from 50 wt % to 95 wt %) having the limiting viscosity ranging from [η]0.5 dl/g to [η]9.0 dl/g, and a boiled heptane soluble polypropylene type resin (from 5 wt % to 50 wt %) having the limiting viscosity of more than [η]1.2 dl/g.

When [η] of a boiled heptane insoluble polypropylene type resin is less than 0.5 dl/g, the chip resistance is extremely decreased, additionally, when it exceeds 9.0 dl/g, the smooth forming process is impossible.

When [η] of a boiled heptane soluble polypropylene type resin is less than 1.2 dl/g, the breaking stress is lower and the rubber elasticity may be inferior.

The aforementioned limiting viscosity is a value that is measured in a decalin solution of 135° C.

Further, it is advisable that the soft transparent polyolefin resin of the soft transparent polyolefin resin sheet is formed by an ethylene-propylene random copolymer (ethylene content ranging from 5 wt % to 30 wt %).

It is desirable that the proportion of ethylene-propylene random copolymer that a unit PPEP composed of continued four elements of ethylene (E) and propylene (P) has a racemic configuration for a continued part of PP is extremely small.

The preferably specific proportion is less than 1%. Thereby improving the flexibility, the tensile strength, the heat resistance and the processability.

The measurement of the proportion can be carried out by, for example, the method referred in page 2208 of the 29^{th} volume of “POLYMER” (1988) and page 138 of the 29^{th} volume of “POLYMER” (1988).

It is desirable that the soft transparent polyolefin resin of the soft transparent polyolefin resin sheet is formed by a non-crystalline butene-1-propylene copolymer.

It is desirable that the soft transparent polyolefin resin of the soft transparent polyolefin resin sheet is formed by a compound of a non-crystalline butene-1-propylene copolymer and polypropylene.

It is desirable that the soft transparent polyolefin resin of the soft transparent polyolefin resin sheet is formed by a propylene-ethylene-butene-1 copolymer.

It is desirable that the soft transparent polyolefin resin of the soft transparent polyolefin resin sheet is formed by a compound of a propylene-ethylene-butene-1 copolymer and polypropylene.

It is desirable that the soft transparent polyolefin resin of the soft transparent polyolefin resin sheet contains a reactor blending type ethylene-propylene copolymer elastomer.

It is desirable that the soft transparent polyolefin resin of the soft transparent polyolefin resin sheet contains a reactor blending type ethylene-propylene-butene-1 copolymer.

It is desirable that the soft transparent polyolefin resin of the soft transparent polyolefin resin sheet is formed by at least one selected from an ethylene monopolymer and an ethylene-α-olefin copolymer.

It is advisable that the ethylene monopolymer is at least one selected from a high-pressure-produced low-density polyethylene and a low-pressure-produced low-density polyethylene.

It is advisable that the ethylene-a-olefin copolymer is at least one selected from a Ziegler-Natta catalyst type linear low-density polyethylene, a metallocene catalyst type linear low-density polyethylene, and an ethylene-octene copolymer having long branching in a main chain polymerized by using C.G.C.T. (Constrained Geometry Catalyst Technology).

The soft transparent polyolefin resin of the soft transparent polyolefin resin sheet according to the present invention may include a soft polypropylene type resin.

The specific examples of the soft polypropylene type resin includes an ethylene propylene copolymer resin, an ethylene-propylene-diene copolymer resin, a propylene-hexene copolymer resin (Japanese Patent Laid-open No. Sho49-53983), an elastic polypropylene (Japanese Patent Laid-open No. Sho61-179247), an atactic polypropylene (Japanese Patent Laid-open No. Sho63-243106), a soft polypropylene of low-stereoregularity (Japanese Patent Laid-open No. Hei3-14851, Japanese Patent Laid-open No. Hei6-263934) and so on.

A layer structure of the soft layer of the soft transparent polyolefin resin sheet is discretionary, in which, for example, a single layer structure or a multilayered structure by co-extrusion can be applied.

The sheet of the invention includes a film that is relatively thinner.

According to the soft transparent polyolefin resin sheet of the present invention, polyvinyl chloride is not included, so that a noxious-gas is not produced and the environment is safeguarded. The soft transparent polyolefin resin such as the soft polypropylene type resin and the hard polypropylene type resin is used, so that the optical qualities, such as transparency, haze and gloss, are enhanced and the heat resistance, the mechanical strength, and the degree of body are sufficient.

A hydrogenated styrene-butadiene rubber of a range from 2 wt % to 30 wt % may preferably be mixed with the soft polypropylene type resin.

When the compounded amount of the hydrogenated SBR is less than 2 wt %, the effects of the transformation (flexibilization) are in vain. When it exceeds 30 wt %, the appearance is inferior by reason of stickiness. In addition, a neck-in is larger in a forming process, so that a stable extrusion is impossible. The more preferable compounded amount ranges from 5 wt % to 20 wt %.

It is desirable that the soft transparent polypropylene type resin is compounded with an ethylene-α-olefin copolymer of a range from 2 wt % to 30 wt %.

As the α-olefin, for example, olefin in which the number of carbons is from 3 to 8 can be used.

When the compounded amount of the ethylene-α-olefin copolymer is less than 2 wt %, the effects of the transformation (flexibilization) are decreased. When it exceeds 30 wt %, the appearance is inferior by reason of stickiness. In addition, a neck-in is larger in a forming process, so that a stable extrusion is impossible. The more preferable compounded amount ranges from 5 wt % to 20 wt %.

It is desirable that an ethylene-octene copolymer of a range from 2 wt % to 30 wt % is mixed in the soft transparent polyolefin resin.

When the compounded amount of the ethylene-octene copolymer is less than 2 wt %, the effects of the transformation (flexibilization) are decreased. When it exceeds 30 wt %, the appearance is inferior by reason of stickiness. In addition, a neck-in is larger in a forming process, so that a stable extrusion is impossible. The more preferable compounded amount ranges from 5 wt % to 20 wt %.

The soft resin of a soft transparent polyolefin resin sheet according to the present invention may include a polypropylene type thermoplastic elastomer; and an ethylene-vinyl acetate copolymer resin.

The specific examples of the polypropylene type thermoplastic elastomer includes an ethylene propylene copolymer resin, an ethylene-propylene-diene copolymer resin, a propylene-hexene copolymer resin (Japanese Patent Laid-open No. Sho49-53983), an elastic polypropylene (Japanese Patent Laid-open No. Sho61-179247), an atactic polypropylene (Japanese Patent Laid-open No. Sho63-243106), a soft polypropylene (Japanese Patent Laid-open No. Hei3-14851), Japanese Patent Laid-open No. Hei6-23934) and so on.

The vinyl acetate content in the ethylene-vinyl acetate copolymer resin normally ranges from 10 wt % to 26 wt %, preferably, from 20 to 26 wt %.

According to the resin sheet of the invention, polyvinyl chloride is not included, so that a noxious-gas is not produced and the environment is safeguarded. When the ethylene-vinyl acetate copolymer resin is included, a dissipation loss is larger, thereby improving the high-frequency heating property.

It is desirable that the content of the ethylene-vinyl acetate copolymer resin ranges from 5 wt % to 30 wt %.

When the content of the ethylene-vinyl acetate copolymer resin is less than 5 wt %, there is no the improved effect for the high-frequency property, and when it exceeds 30 wt %, the transparency is inhibited. The preferable content ranges from 20 wt % to 30 wt %.

An anti-oxidizing agent, an anti-blocking agent, a sliding agent, a nucleating agent, an antistat, an ultraviolet absorption agent, a weathering agent, an anti-fungus agent, a petroleum resin and so on may be added to the soft transparent polyolefin resin sheet of the present invention within the range in which the properties are not inhibited.

Since the soft transparent polyolefin type resin sheet according to a first aspect of the present invention includes the soft resin layer as a main component, neck-in can be caused in single-layer molding according to a selected soft resin. A multi-layered structure with the hard polypropylene layer can improve moldability of the sheet.

Further, the sheet can be used to produce a folded container, a self-standing container and a bag.

The fourth aspect of the present invention is a method for producing a soft transparent polyolefin resin sheet, which uses a producing apparatus having a cooling roller, a metallic endless member abutting through the resin sheet to the cooling roller, and an elastic member placed under a face of the metallic endless member at a place where the resin sheet is cooled after the resin sheet is guided between the cooling roller and the metallic endless member. The method is characterized by the steps of: guiding the soft transparent polyolefin resin sheet according to any one of the first, second and third inventions in the molten state between the cooling roller and the metallic endless member so that the resin sheet simultaneously touches both the cooling roller and the endless member in contact with the cooling roller; and areally pressuring and cooling the soft transparent polyolefin resin sheet while the elastic member is being elastically deformed.

Here, the resin sheet in the molten state is, for example, a resin sheet just after being extruded from a die of an extruder.

As the materials of the elastic member, a fluorine type rubber, a silicone type rubber, EPDM and so on can be used. The preferable thickness of the elastic member is more than 3 mm in order to obtain a sufficient areal pressure through the elastic deformation.

Preferably, each surface of the metallic endless member and the roller on which the resin sheet is touched is a mirror face, in which, for example, the arithmetic average surface-roughness S is less than 0.5 μm.

As the materials of the endless member, stainless steel, carbon steel, titanium alloy and so on can be used. The thickness of the endless member is discretionary, but the preferable thickness is more than 0.3 mm from the viewpoint of strength.

In the invention, the resin sheet is areally pressured (pressured over an area) and cooled as the elastic member becomes elastically deformed, so that the efficiency of the cooling and the mirror transfer is enhanced.

The resin sheet is guided between the cooling roller and the metallic endless member to touch both the cooling roller and the metallic endless member in contact with the cooling roller, at approximately the same time, so that the pressuring process and the cooling process for the resin sheet are concurrently carried out, thereby improving the transparency of the resin sheet. If the resin sheet is touched with the metallic endless member or the cooling roller, one earlier than the other, the resin sheet must be cooled and solidified before the mirror face is transferred onto both faces of the sheet.

In the producing method of the present, it is advisable that the metallic endless member is wound on at least two rollers; and that the elastic member is formed on the outer circumferential surface of the cooling roller of the rollers wound with the metallic endless member.

In other words, the metallic endless member is a metallic endless belt wound on at least two rollers.

Inside of the metallic endless belt, a cooling roller or a roller for controlling tension can be provided as a roller besides the aforementioned two rollers.

In the producing method, one of the metallic endless members may be wound on the cooling rollers to run with the other metallic endless member in parallel, in which the soft transparent polyolefin resin sheet according to any one of the first, second and third inventions is guided in the molten state between the metallic endless members so that the resin sheet simultaneously touches both the endless members, and the soft transparent polyolefin resin sheet is areally pressured and cooled while the elastic member is being elastically deformed.

As permitted in the invention, the soft transparent polyolefin resin sheet is cooled by being sandwiched between the two metallic endless members.

In the producing method according to the present invention, the elastic member can be formed on the outer circumferential surface of the roller, and the metallic endless member may cylindrically formed on the outer circumferential surface of the elastic member.

As permitted in the invention, the metallic endless member is formed as the outer layer of the roller.

It is advisable that the temperature of the cooling roller and the metallic endless member in direct contact with the resin sheet ranges from the dew point to 50° C.

When the temperature of the roller and the metallic endless member which are for cooling the resin sheet is lower than the dew point, droplet spots are produced on the sheet. Alternatively, when it exceeds 50° C., sufficient transparency cannot be obtained. Therefore, the preferable temperature is less than 30° C.

It is desirable that the area pressure when the resin sheet is pressured with the elastically deformed elastic member ranges 0.1 MPa to 20.0 MPa.

The area pressure of lower than 0.1 MPa causes the efficiency of the mirror transfer and the cooling to be decreased. On the other hand, the area pressure of more than 20.0 MPa causes tension to be increased when the endless belt is used, therefore being unacceptable from the viewpoint of long lasting qualities.

It is desirable that the elastic member has the hardness (adherence to JIS K6301 type) of less than 95 degrees.

When the hardness is more than 95 degrees, the elastic force is decreased and resin banks are easily produced when the resin sheet is touched by both the cooling roller and the metallic endless member at approximately the same time.

In the fourth invention, the obtained resin sheet can undergo an annealing treatment.

The annealing process is carried out, for example, from 80° C. to 130° C., preferably, 110° C. to 130° C. The annealing process allows the hardness of the face of the sheet to be increased.

### BRIEF DESCRIPTION OF THE DRAWINGS

FIG. 1 is a diagrammatic view of a producing apparatus used in a producing method of a soft transparent polyolefin resin sheet according to each of first, fourth and fifth embodiments of the present invention;

FIG. 2 is a diagrammatic view of a producing apparatus used in a producing method of a soft transparent polyolefin resin sheet according to a second embodiment of the present invention;

FIG. 3 is a diagrammatic view of a producing apparatus used in a producing method of a soft transparent polyolefin resin sheet according to a third embodiment of the present invention.

### DETAILED DESCRIPTION OF THE PREFERRED EMBODIMENT(S)

First Embodiment

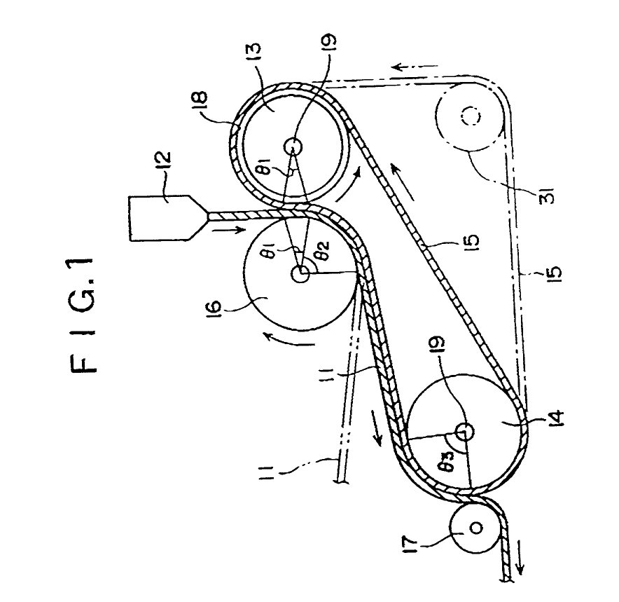

A soft transparent polyolefin resin sheet 11 and a method for producing the same according to the embodiment will be described hereinafter with reference to FIG. 1.

At the outset, a structure of a producing apparatus used in the producing method of the embodiment will be explained.

The producing apparatus is composed of: a T-die 12 of an extruder (not shown); a metallic endless belt 15 wound on a first cooling roller 13 and a second cooling roller 14; a third cooling roller 16 that is in contact with the first cooling roller 13 through the resin sheet 11 and the metallic endless belt 15; and a fourth roller 17 placed adjacent to the second cooling roller 14.

The first cooling roller 13 is covered with an elastic member 18, such as fluoro rubber, on the outer circumference surface. The elastic member 18 has the hardness (adherence to JIS K6301 A-type) of less than 95 degrees and the thickness of more than 3 mm.

The metallic endless belt 15 is made of stainless or the like and has a mirror surface having the surface-roughness S of less than 0.5 μm.

At least one of rotating shafts 19 of the first and second cooling rollers 13 and 14 is connected with a rotary driving means (not shown).

The third roller 16 also has a mirror surface having the surface-roughness S of less than 0.5 μm. The third roller 16 is placed in contact with the first roller 13 through the resin sheet 11 and the metallic endless belt 15 and held by the resin sheet 11 that is pressured toward the cooling roller 16 by the endless belt 15. In other words, the metallic endless belt 15 and the resin sheet 11 laid on the endless belt 15 run in a curve to wind on a part of an outer circumferential surface of the third cooling roller 16.

The fourth roller 17 guides the resin sheet 11 to pressure it onto the second cooling roller 14 through the endless belt 15.

The first and third cooling rollers 13 and 16 of the cooling rollers each have a temperature controlling means, such as a water-cooling system (not shown), for controlling the temperature of the surface of the roller. The temperature controlling means is not provided in the cooling roller 14, but may be provided.

As indicated with a dashed and dotted line of FIG. 1, a cooling roller 31 can be placed forward the first cooling roller 13 inside the endless belt 15, thereby the upstream portion of the endless belt 15 is cooled in advance before reaching the first cooling roller 13. Additionally, the cooling roller 31 functions as a roller for controlling tension of the endless belt 15.

Next, the method for producing the soft transparent polyolefin resin sheet of the embodiment with the use of the aforementioned producing apparatus will be hereinafter described.

Each temperature of the cooling rollers 13, 14 and 16 is controlled to maintain the surface temperature of the third cooling roller 16 and the metallic endless belt 15 that is in direct contact with the resin sheet 11 to be from the dew point to 50° C.

As the materials of the resin sheet 11 are fed into the extruder, when a single layer sheet is fabricated, pellets of a soft polypropylene type resin are put in readiness for using. When a multilayered layer sheet is fabricated, pellets of a hard polypropylene type resin are additionally put in readiness for using.

The resin sheet 11 is extruded from the T-die 12 after the materials of the resin sheet 11 are fed into the extruder and meltingly kneaded. The extruded resin sheet 11 is guided between the first and third cooling rollers 13 and 16 to touch both the third cooling roller 16 and the endless belt 15 in contact with the first cooling roller 13. The resin sheet 11 is pressed between the first and third cooling rollers 13 and 16 and cooled at less than 50° C. Here, the elastic member 18 is elastically deformed to be compressed is with the pressure force produced between the first and third cooling rollers 13 and 16. Therefore, the resin sheet 11 is areally pressured (pressured over a given area) by the cooling rollers 13 and 16 in angles θ1 formed from the centers of the cooling roller 16 and the cooling roller 13 having the elastically deformed elastic member 18. The areal pressure is from 0.1 MPa to 20.0 MPa.

Continuously, the resin sheet 11 is cooled at less than 50° C. by being pressured onto the third cooling roller 16 by using the endless belt 15 having the mirror surface. The resin sheet 11, which is pressured onto the third cooling roller 16 by the endless belt 15, holds the third cooling roller 16 at an angle θ2 formed from the center of the roller 16, so that the resin sheet 11 is pressured by the endless belt 15 and the third cooling roller 16 in the area formed by the angle θ2. The area pressure is from 0.01 MPa to 0.5 MPa.

After that, the resin sheet 11 is moved toward the second cooling roller 14 with the rotation of the endless belt 15 while being laid on the endless belt 15, and cooled at less than 50° C. by being pressured through the endless belt 15 to the second cooling roller 14 so as to fabricate the soft transparent polyolefin resin sheet 11 according to the embodiment. When the fourth roller 17 guides the resin sheet 11 to pressure toward the cooling roller 14, the resin sheet is pressured through the endless belt 15 to the cooling roller 14 at an angle θ3 formed from the center of the roller 14. The pressure is from 0.01 MPa to 0.5 MPa.

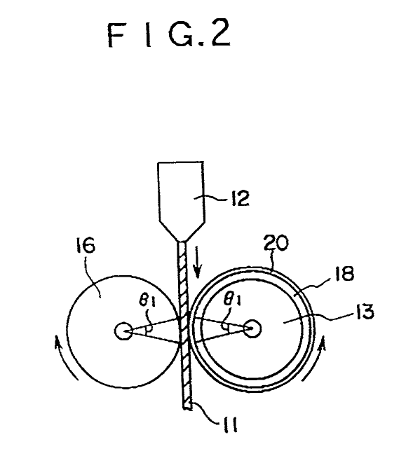

Note that, as indicated with a dashed and two-dotted line of FIG. 1 and FIG. 2, the resin sheet 11 can be peeled from the endless belt 15 just after being cooled by the first and third rollers 13 and 16.

According to the embodiment, the molten resin sheet 11 that is extruded from the T-die 12 by using a polyolefin type resin as the raw materials is areally pressured and cooled by using the cooling rollers 13 and 16 in the area formed by the angles θ1 of the first and third cooling rollers 13 and 16 in which the elastic member 18 is elastically deformed. Continuously, the resin sheet 11 is areally pressured and cooled by using the metallic endless belt 15 and the third cooling roller 16 at the angle θ2, and additionally, is pressured and cooled by using the endless belt 15 and the second cooling roller 14 at the angle θ3 of the second cooling roller 14. Therefore, the obtained resin sheet 11 has the following properties (a) to (c).

(a) The modulus of elasticity is from 20 MPa to 1,000 MPa.

(b) The average length of a foreign substance that has a different refractive index from a non-crystalline resin composition occupying the most volume fraction is less than 10 μm, and the number of foreign substances in any section of the face of the sheet is less than 500 foreign substances/mm².

(c) The surface-roughness Ra of at least one of faces is less than 0.2 μm.

Second Embodiment

A soft transparent polyolefin resin sheet 11 and a producing method of the same according to the embodiment will be described hereinafter with reference to FIG. 2.

A producing apparatus used in the embodiment uses a metallic endless layer 20 that is formed on the outer circumferential of elastic member 18 of the first cooling roller 13 instead of the metallic endless belt 15 which is wound on the first cooling roller 13 and the second cooling roller 14 in the first embodiment.

In the producing method using the producing apparatus of the embodiment, the molten resin sheet 11 which is extruded from the T-die 12 with the use of a polyolefin type resin as the raw materials is areally pressured and cooled by using the cooling rollers 13 and 16 in an area formed by angles θ1 of the first and third cooling rollers 13 and 16 in which the elastic member 18 is elastically deformed. Thereby obtaining the resin sheet 11 having the aforementioned properties (a) to (c).

Third Embodiment

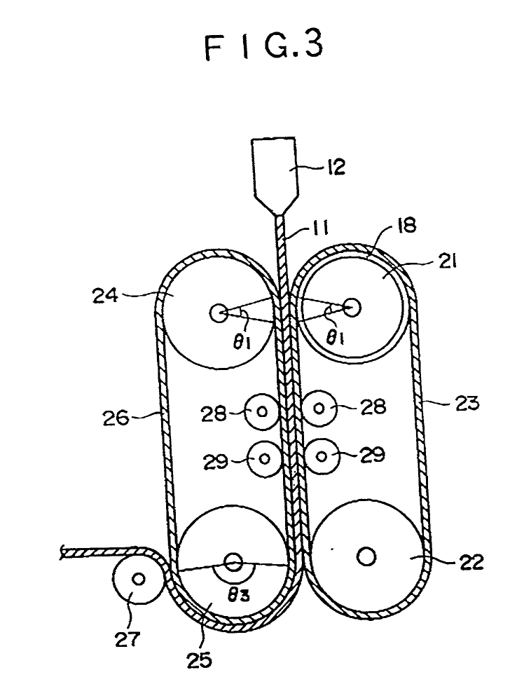

A soft transparent polyolefin resin sheet 11 and a method for producing the same according to the embodiment will be described hereinafter with reference to FIG. 3.

At the outset, a structure of a producing apparatus used in the embodiment will be explained below.

The producing apparatus is composed of: the T-die 12 of the extruder; a first metallic endless belt 23 which is wound on a first cooling roller 21 and a second cooling roller 22; a second metallic endless belt 26 which is wound on a third cooling roller 24 and a fourth cooling roller 25; a fifth roller 27 which is placed adjacent to the fourth cooling roller 25; and two pairs of rollers 28 and 29 placed as a pressure applying means for pressuring the endless belts 23 and 26.

The first cooling roller 21 is covered with the elastic member 18, such as fluoro rubber, on the surface. The elastic member 18 has the hardness (adherence to JIS K6301 A-type) of less than 95 degrees and the thickness of more than 3 mm.

The first and second endless belts 23 and 26 run parallel to sandwich the soft transparent polyolefin resin sheet 11 in between the first and second cooling rollers 21 and 22 and between the third and fourth cooling rollers 24 and 25. The endless belts 23 and 26 are made of stainless steel or the like and have a mirror surface having the surface-roughness of less than 0.5 S.

Each pair of rollers 28 and 29 as the pressure applying means, are with the endless belts 23 and 26 in between, and are located in the middle section from the first and third cooling rollers 21 and 24 to the second and fourth cooling rollers 22 and 25. The upper pair of rollers 28 and the lower pair of rollers 29 are spaced to some degree from each other. Each pair of rollers 28 and 29 can be placed in a zigzag not to be opposite to each other.

The fifth roller 27 guides the soft transparent polyolefin resin sheet 11 so that the resin sheet 11 is pressured through the second endless belt 26 to the fourth cooling roller 25.

Each of the cooling rollers 21, 22, 24 and 25 has a temperature controlling means, such as a water-cooling system (not shown), for controlling the temperature of the surface of the roller.

Next, the method for producing the soft transparent polyolefin resin sheet 11 of the embodiment by using the aforementioned producing apparatus will be explained below.

Each temperature of the cooling rollers 21, 22, 24 and 25 are controlled so that each surface temperature of the metallic endless belts 23 and 26 that is in directly contact with the resin sheet 11 is maintained from the dew point to 50° C.

The soft transparent polyolefin resin sheet 11 which is extruded from the T-die 12 is guided between the first and second endless belts 23 and 26 to touch both the first metallic endless belt 23, which is directly laid on the first cooling roller 21, and the second metallic endless belt 26 which is directly laid on the third cooling roller 24. The soft transparent polyolefin resin sheet 11 is pressured by the first and third cooling rollers 21 and 24 and cooled at less than 50° C. Here, the elastic member 18 is elastically deformed to be compressed with the pressure force produced between the first and third cooling rollers 21 and 24. Therefore, an area of the resin sheet 11 is pressured by the cooling rollers 21 and 24 in angles θ1 formed from the centers of the cooling roller 24 and the cooling roller 21 having the elastically deformed elastic member 18. The area pressure is from 0.1 MPa to 20.0 MPa.

Continuously, the soft transparent polyolefin resin sheet 11 that is sandwiched between the endless belts 23 and 26 by using two pairs of rollers 28 and 29 as the pressure applying means is pressured and cooled at less than 50° C. while being parallel run together with the endless belts 23 and 26. The resin sheet 11 that is sandwiched between the endless belts 23 and 26 in a section between the upper and lower pairs of rollers 28 and 29 is pressured by the pressure force of the pairs of rollers 28 and 29. The pressure is from 0.01 MPa and 0.5 MPa.

After that, the soft transparent polyolefin resin sheet 11 is moved toward the second and fourth cooling rollers 22 and 25 with the rotation of the endless belts 23 and 26, and cooled at less than 50° C. by being pressured through the second endless belt 26 toward the fourth cooling roller 25. The polyolefin resin sheet 11 which is guided by the fifth roller 27 to be pressured toward the fourth cooling roller 25 is areally pressured onto the endless belt 26 in a section formed by an angle θ3 from the center of the cooling roller 25. The areal pressure is from 0.01 MPa to 0.5 MPa.

According to the embodiment, the processes for areally pressuring and cooling the resin sheet 11 are carried out in the section formed by the angles θ1 of the third cooling roller 24 and the first cooling roller 21, having the elastically deformed elastic member 18, by the first and third cooling roller 21 and 24 and the endless belts 23 and 26, continuously, between the two pairs of rollers 28 and 29 as the pressure applying means, and further, in the section formed by the angle θ3 by the second metallic endless belt 26 and the fourth cooling roller 25. Thereby obtaining the resin sheet 11 having the aforementioned properties (a) to (c).

Fourth Embodiment

The structure of the apparatus used in a producing method relating to the embodiment is the same as that in the first embodiment.

The method for producing the soft transparent polyolefin resin sheet 11 with the use of the producing apparatus is parallel with that of the first embodiment. In the embodiment, as the raw materials of the resin sheet 11 which is fed into the extruder, pellet that consists of a soft polypropylene type resin and pellet that is made by adding one of three components of a hydrogenated SBR, an ethylene-(αolefin copolymer and an ethylene-octene copolymer in the soft polypropylene type resin are put in readiness for using.

According to the embodiment, the resin sheet 11, which is manufactured of the materials of the soft polypropylene type resin or the material that is compounded of the resin and one of three components of a hydrogenated SBR, an ethylene-αolefin copolymer and an ethylene-octene copolymer, and is extruded from the T-die 12, is areally pressured and cooled with the cooling rollers 13 and 16 in the section formed by the angle θ1 of the cooling roller 16 and the cooling roller 13 having the elastically deformed elastic member 18. Continuously, the sheet 11 is areally pressured and cooled in the angle θ2 by using the metallic endless belt 15 and the third cooling roller 16. Additionally, after that, the sheet 11 is area pressured and cooled in the angle θ3 of the second cooling roller 14 by using the endless belt 15 and the second cooling roller 14. Thereby fabricating the resin sheet 11 having the high transparency at high speed.

Fifth Embodiment

In the fifth embodiment, the producing apparatus similar to that in the first embodiment is used.

As the raw materials of the resin sheet 11 that is fed into the extruder, pellet that consists of a polypropylene type thermoplastic elastomer and an ethylene-vinyl acetate copolymer resin (5 wt % to 30 wt %) is put in readiness for using. The soft transparent polyolefin resin sheet 11 is fabricated with the use of the aforementioned materials as described in the first embodiment.

According to the embodiment, with respect to the resin sheet 11 which is made by using a polypropylene type thermoplastic elastomer and an ethylene-vinyl acetate copolymer resin (from 5 wt % to 30 wt %) as the material, and is extruded from the T-die 12, the first and third cooling rollers 13 and 16 areally pressure and cool the resin sheet in the section formed by the angle θ1 of the cooling rollers 16 and 13 which has the elastically deformed elastic member 18. Continuously, the metallic endless belt 15 and the third cooling roller 13 areally pressure and cool the resin sheet in the section formed by the angle θ2. Additionally, after that, the endless belt 15 and the second cooling roller 14 areally pressure and cool the resin sheet in the section formed by the angle θ3 of the second cooling roller 14. Therefore, the resin sheet 11 having the high transparency can be fabricated at high speed.

Experiments 1 to 17

Referring to the first embodiment, the resin sheet 11 is fabricated by changing specific examples and the compounding proportions of the raw materials of the sheet from each experiment.

The resin sheets 11 relating to Experiments 1 to 8 have a single layer structure. Table 1 shows in reference to the aforementioned properties (a) to (c) of each resin sheet 11 of Experiments.

Diameter of the extruder . . . 90 mm, width of the T-die . . . 800 mm.

Materials of the elastic member . . . silicone rubber, thickness . . . 10 mm, hardness . . . 30 degrees.

Processing speed of the sheet . . . 16 m/min.

Surface temperature of the roller and the endless belt that is on contact with the sheet . . . 20° C.

Soft polyolefin type resin of Experiment 1 . . . a low-stereoregular homo-polypropylene (MI: 3.1 g/10 min., density: 0.90 g/m³, an elastic modulus in tension: 500 MPa, PI: 76%, rrrr/(1-mmmm): 24.2%, boiled heptane insolubles: 90 wt %). TPO E-2900 (trade name) made by Idemitsu Petrochemical Co., Ltd. The thickness of the sheet . . . 0.2 mm.

Soft polyolefin type resin of Experiment 2 . . . multiple polymerization reactor is used for a compounding process. An ethylene-propylene copolymer (MI: 0.84 g/10 min., density: 0.89 g/cm³ , an elastic modulus in tension: 150 MPa), having a form in which a component of an ethylene-propylene rubber (EPR) of approximately 43 wt % is evenly fine-dispersed. CATALLOY KS-082P (trade name) made by HIMONT Inc. The thickness of the sheet . . . 0.3 mm.

Soft polyolefin type resin of Experiment 3 . . . multiple polymerization reactor is used for a compounding process. An ethylene-propylene copolymer (MI: 0.60 g/10 min., density: 0.89 g/cm³, an elastic modulus in tension: 100 MPa), having a form in which a component of EPR of approximately 50 wt % is evenly fine-dispersed. CATALLOY KS-052P (trade name) made by HIMONT Inc. The thickness of the sheet . . . 0.3 mm.

Soft polyolefin type resin of Experiment 4 . . . an ethylene-propylene random copolymer (MI: 1.50 g/10 min., density: 0.88 g/cm³, an elastic modulus in tension: 100 MPa), in which a soft segment and a hard segment are produced from ethylene of 20 wt % and propylene of 80 wt % by using a single-stage reactor. PER T-310E (trade name) made by TOKUYAMA Corp. The thickness of the sheet . . . 0.2 mm.

Soft polyolefin type resin of Experiment 5 . . . an ethylene-propylene random copolymer (MI: 1.50 g/10 min., density: 0.88 g/cm³, an elastic modulus in tension: 120 MPa), that is compounded from ethylene of 10 wt % and propylene of 90 wt % as in Experiment 4. PER T-310J (trade name) made by TOKUYAMA Corp. The thickness of the sheet . . . 0.2 mm.

Soft polyolefin type resin of Experiment 6 . . . a resin composition which a low-stereoregular homo-polypropylene, as used in Experiment 1, of 70 wt % and a hydrogenated styrene-butadiene rubber (trade name: DYNALON 1320 P made by Japan Synthetic Rubber Co., Ltd.) of 30 wt % are blended. The thickness of the sheet . . . 0.3 mm.

Soft polyolefin type resin of Experiment 7 . . . a resin composition which a low-stereoregular homo-polypropylene, as used in Experiment 1, of 80 wt % and an ethylene-propylene rubber (EPR) (trade name: TAFMER P0280 made by MITSUI CHEMICAL CO., LTD.) of 20 wt % are blended. The thickness of the sheet . . . 0.3 mm.

Soft polyolefin type resin of Experiment 8 . . . a resin composition which a low-stereoregular homo-polypropylene, as used in Experiment 1, of 85 wt % and an ethylene-octene copolymer (trade name: ENGAGE EG-8200 made by DOW CHEMICAL Company) of 15 wt % are blended. The thickness of the sheet. . . 0.3 mm.

The resin sheets 11 relating to Experiments 9 to 11 have a double layer structure.

Soft polyolefin type resin of one layer of the sheet relating to Experiment 9 . . . a low-pressure-produced linear low-density polyethylene (L-LDPE MI: 3 g/10 min., density: 0.907 g/cm³). MORETEC V-0398CN (trade name) made by Idemitsu Petrochemical Co., Ltd. The thickness . . . 120 μm.

Resin of the other layer of the sheet in Experiment 9 . . . a hard polypropylene type resin. F-704 NP (trade name) made by Idemitsu Petrochemical Co., Ltd. The thickness . . . 80 μm.

Soft polyolefin type resin of one layer of the sheet relating to Experiment 10 . . . an ethylene-octene copolymer (MI: 1 g/10 min., density: 0.902 g/cm³) that has long branching in a main chain which is polymerized by using C. G. C. T. (Constrained Geometry Capatlyst Technology). PLASTOMER AFFINITY PL1880 (trade name) made by DOW CHEMICAL Company. The thickness . . . 120 μm.

Resin of the other layer of the sheet relating to Experiment 10 . . . a hard polypropylene type resin. F-704NP (trade name) made by Idemitsu Petrochemical Co., Ltd. The thickness . . . 80 μm.

Soft polyolefin type resin of one layer of the sheet relating to Experiment 11 . . . an ethylene-octene copolymer (MI: 1 g/10 min., density: 0.902 g/cm³) that has long branching in a main chain which is polymerized by using C. G. C. T. PLASTOMER AFFINITY PL1880 (trade name) made by DOW CHEMICAL Company. The thickness . . . 160 μm.

Resin of the other layer of the sheet relating in Experiment 11 . . . a hard polypropylene type resin. F-704NP (trade name) made by Idemitsu Petrochemical Co., Ltd. The thickness . . . 40 μm.

The resin sheets 11 relating to Experiments 12 to 17 have a three-layer structure.

Soft polyolefin type resin used for each middle layer of the sheet relating to Experiments 12 to 14 . . . a resin composition (an elastic modulus in tension: 100 MPa) that is compounded by blending an amorphous polyolefin (density: 0.86 g/cm³, melting viscosity in 190° C.: 10,000 cps) of 50 wt %, compounded by means of a random copolymerization of butene-1 (35 wt %) and propylene (65 wt %), and a crystalline polypropylene (MI: 1.00 g/10 min., density: 0.90 g/cm³) of 50 wt %. CAP-355 (trade name) made by UBE REXSEN CO., LTD . . . The thickness of the middle layer . . . 0.16 mm.

Resin used for the outer layers of each sheet relating to Experiments 12 to 14 . . . a hard polypropylene type resin. F-704NP (trade name) made by Idemitsu Petrochemical Co., Ltd. The thickness of the outer layer . . . 0.02 mm.

Soft polyolefin type resin used for a middle layer of the sheet relating to Experiment 15 . . . a high-pressure-produced low-density polyethylene (LDPE, MI: 4 g/10 min., density: 0.921 g/cm³). PETROTHEN 190 (trade name) made by TOHSO Corporation. The thickness of the middle layer 0.16 mm.

Resin used for the outer layers of the sheet relating to Experiment 15 . . . random polypropylene (an ethylene-propylene random copolymer, ethylene content: 4 wt %, MI: 11 g/10 min.). GRAND POLYPRO S235 (trade name) made by GRAND POLYMER CO., LTD. The thickness of the outer layer . . . 0.02 mm.

Soft polyolefin type resin used for a middle layer of the sheet relating to Experiment 16 . . . a low-pressure-produced linear low-density polyethylene (L-LDPE, MI: 3 g/10 min., density: 0.907 g/cm³). MORETEC V-0398CN (trade name) made by Idemitsu Petrochemical Co., Ltd. The thickness of the middle layer . . . 0.16 mm.

Resin used for the outer layers of the sheet relating to Experiment 16 . . . random polypropylene (an ethylene-propylene random copolymer, ethylene content: 4 wt %, MI: 11 g/10 min.). GRAND POLYPRO S235 (trade name) made by GRAND POLYMER CO., LTD. The thickness of the outer layer . . . 0.02 mm.

Soft polyolefin type resin used for a middle layer of the sheet relating to Experiment 17 . . . an ethylene-octene copolymer (MI: 1 g/10 min., density: 0.902 g/cm³) that has long branching in a main chain which is polymerized by using a metallocene catalyst type geometrical restrain catalyst. PLASTOMER AFFINITY PL1880 (trade name) made by DOW CHEMICAL Company. The thickness of the middle layer 0.16 mm.

Resin used for the outer layers of the sheet relating to Experiment 17 . . . random polypropylene (an ethylene-propylene random copolymer, ethylene content: 4 wt %, MI: 7 g/10 min.). F-744NP (trade name) made by Idemistu Petrochemical Co., Ltd. The thickness of the outer layer 0.02 mm.

Comparisons 1 and 2

A resin sheet is produced by a conventional touch roll sheet forming method using a cooling roller. The temperature of the cooling roller is 40° C.

In Comparison 1, the raw materials of resin is the same as that in Experiment 1.

In Comparison 2, the same three-layer structure as Experiment 15 is used and the raw materials of resin is the same as that in Experiment 15.

Evaluations Concerning Properties

The resin sheets, obtained in Experiments 1 to 17 and Comparisons 1 and 2, are measured about an average length (size) of a foreign substance, the surface-roughness, haze (total haze/inner haze), gloss, and a modulus of elasticity (modulus in tension). The results are shown in Tables 1 and 2. The number of foreign substances ranges from 100 to 400 pieces of a foreign substance in each of Experiments 1 to 14.

The average length of the foreign substance ranges from 1 μm to 5 μm in each of Experiments 1 to 14. The average length is measured by using a phase-contrast microscope.

The surface-roughness is measured in conformity with JIS B 0610-1982. With the use of an electronic line tridimensional roughness-analysis equipment (trade name: ERA-4000) made by ELIONIX CO., LTD. as a measuring equipment, an image is inspected at 1,500 times. Additionally, an average roughness at the central face Ra is calculated through measuring microscopic asperities on a sample surface by using an electronic probe. The measurement is carried out for the inside face and the outside face of the sheet that is wound on a roller.

The haze is found from the following formula by using the ratio of a total light transmittance (Tt), showing the amount of transmitting light when light is irradiated onto and passes through the sheet, to a diffuse light transmittance (Td) in which light transmits to be difflused by the sheet, with the use of a haze measuring instrument (e.g., trade name: NDH-300A made by NIPPON DENSHOKU KOUGYO CO., LTD.). The total light transmittance is the sum of the diffuse light transmittance (Td) and a parallel light transmittance (Tp) in which light transmits along the same axial as incident light.

Haze(H)=Td/Tt×100

The total haze is found from Tt and Td obtained when light is irradiated onto the sheet. The inner haze is measured to eliminate influences from the outside of the sheet by sandwiching the sheet between glass plates after silicone oil is coated on both faces of the sheet.

Total haze=inner haze+outer haze

The gloss is found from the following formula by using a ratio of a reflected light beam ψs, that is measured when light is irradiated onto the sheet at the incident angle of 60 degrees and a reflected light is also received at 60 degrees, to a reflected light beam ψos that is reflected from the surface of glass having a refractive index of 1.567, with the use of an automatic colorimetric color-difference meter (e.g., trade name: AUD-CH-model 2-45, 60 made by SUGA SHIKENKI CO., LTD.).

Gloss(Gs)=(ψs/ψos)×100

The elastic modulus in tension is measured in conformity with JIS K-7113.

TABLE 1

| | | Elastic | Size of | Surface- | | | | |
|---|---|---|---|---|---|---|---|---|
| | | modulus in | foreign | Roughness | | | | |
| | Composition & layer | tension | substance | (μm) | | Haze (%) | | Gloss |
| | structure of sheet | (MPa) | (μm) | inner | outer | total | inner | (%) |
| E1 | low-stereoregular PP | 500 | <10 | 0.027 | 0.031 | 2.5 | 1.5 | 135 |
| E2 | EPR fine-dispersion E- | 150 | <10 | 0.028 | 0.035 | 6 | 3 | 110 |
| | P copolymer | | | | | | | |
| E3 | EPR fine-dispersion E- | 100 | <10 | 0.032 | 0.034 | 5 | 2 | 100 |
| | P copolymer | | | | | | | |
| E4 | E-P random | 100 | <10 | 0.039 | 0.038 | 5 | 2.5 | 110 |
| | copolymer | | | | | | | |
| E5 | E-P random | 120 | <10 | 0.042 | 0.034 | 3 | 1.5 | 120 |
| | copolymer | | | | | | | |
| E6 | low-stereoregular PP/ | 150 | <10 | 0.029 | 0.033 | 2 | 1 | 130 |
| | hydrogenated SBR | | | | | | | |
| E7 | low-stereoregular PP/ | 450 | <10 | 0.027 | 0.034 | 3.5 | 1.5 | 120 |
| | E-O | | | | | | | |
| E8 | low-stereoregular PP/ | 400 | <10 | 0.033 | 0.041 | 2 | 1.5 | 130 |
| | E-O | | | | | | | |
| E9 | PP//L-LDPE | 120 | <10 | 0.033 | 0.032 | 3 | 1.5 | 120 |
| E10 | PP//Plastomer | 130 | <10 | 0.021 | 0.037 | 4 | 2 | 120 |
| E11 | PP//Plastomer | 100 | <10 | 0.034 | 0.031 | 4 | 1.5 | 130 |
| E12 | PP//amorphous | 120 | <10 | 0.041 | 0.035 | 1 | 0.2 | 130 |
| | PO//PP | | | | | | | |
| E13 | PP//amorphous | 200 | <10 | 0.027 | 0.034 | 0.8 | 0.5 | 130 |
| | PO//PP | | | | | | | |
| E14 | PP//amorphous | 200 | <10 | 0.034 | 0.032 | 0.7 | 0.5 | 130 |
| | PO//PP | | | | | | | |
| E15 | PP//LDPE//PP | 200 | <10 | 0.035 | 0.037 | 6 | 3 | 120 |
| E16 | PP//L-LDPE//PP | 120 | <10 | 0.036 | 0.034 | 4 | 1.6 | 120 |
| E17 | PP//Plastomer//PP | 100 | <10 | 0.039 | 0.031 | 3 | 1.7 | 130 |

E1 to E17 are Experiments 1 to 17.
PP is polypropylene.
EPR is ethylene-propylene rubber.
E-P is ethylene-propylene.
PO is polyolefin.
SBR is styrene-butadiene rubber.
E-O is ethylene-octene.

TABLE 2

| | | Elastic | Size of | Surface- | | | | |
|---|---|---|---|---|---|---|---|---|
| | | modulus in | foreign | Roughness | | | | |
| | Composition & layer | tension | substance | (μm) | | Haze (%) | | Gloss |
| | structure of sheet | (mPa) | (μm) | inner | outer | total | inner | (%) |
| C1 | low-stereoregular PP | 700 | 15 | 0.26 | 0.27 | 10 | 8 | 80 |
| C2 | PP//amorphous | 150 | 20 | 0.074 | 0.075 | 10 | 1 | 95 |
| | PO/PP | | | | | | | |

C1 and C2 are Comparisons 1 and 2.

From Table 1, according to the soft transparent polyolefin resin sheets 11 of Experiments 1 to 8, the sheet is made of a soft polyolefin type resin having the aforementioned properties (a) to (c), so that the sufficient transparency can be obtained by reason of the lower total haze and inner haze. Additionally, an appropriate shine can be obtained by reason of the high gloss.

According to the soft transparent polyolefin resin sheets 11 of Experiments 9 to 17, it is concluded that the effective properties can be similarly obtained even in the multilayered structure in which at least one of both the outer faces is made of a hard polypropylene type resin.

The producing method according to the present invention allows fabrication of the soft transparent polyolefin resin sheet 11 having the aforementioned properties (a) to (c).

From Table 2, according to Comparison 1, the total haze and the inner haze are higher, so that the obtained resin sheet is inferior in the transparency. Additionally, a shine is low grade by reason of the lower gloss.

According to Comparison 2, the transparency of the obtained resin sheet results are less than adequate for the higher total haze. Additionally, a shine is dull by reason of the lower gloss.

Experiments 18 to 21

Referring to the second embodiment, the resin sheet 11 is fabricated to change specific examples and the compounding proportions of the raw materials of the sheet, and so on in each experiment as described hereinafter. The resin sheets 11 relating to Experiments 18 to 21 each have a three-layer structure. Table 3 shows the aforementioned properties (a) to (c) which are shown in the resin sheet 11 obtained in each experiment. The specific conditions for producing are the same as in Experiment 1.

The resin used for the middle layer and the outer layers of Experiment 18 is as is the case with Experiment 12.

The resin used for the middle layer and the outer layers of Experiment 19 is as is the case with Experiment 15.

The resin used for the middle layer and the outer layers of Experiment 20 is as is the case with Experiment 16.

The resin used for the middle layer and the outer layers of Experiment 21 is as the case of Experiment 17.

Comparisons 3 and 4

The resin sheet is made by the same manner as the Comparison 1.

The structure of the resin sheet and the composition of resin relating to Comparisons 3 and 4 are the same as that in Comparisons 1 and 2.

Evaluations Concerning Properties

As regards the resin sheets obtained in Experiments 18 to 21 and Comparisons 3 and 4, the average length of the foreign substance, the surface-roughness, haze, gloss, and the elastic modulus in tension are measured. The results are shown in Tables 3 and 4. The number of foreign substances is sighted in a range from 100 to 400 foreign substances in each of Experiments 18 to 21.

The average length of the foreign substance ranges from 1 μm to 5 μm in each of Experiments 18 to 21.

TABLE 3

| | | Elastic | Size of | Surface- | | | | |
|---|---|---|---|---|---|---|---|---|
| | | modulus in | foreign | Roughness | | | | |
| | Composition & layer | tension | substance | (μm) | | Haze (%) | | Gloss |
| | structure of sheet | (MPa) | (μm) | inner | outer | total | inner | (%) |
| E18 | PP//amorphous | 130 | <10 | 0.031 | 0.039 | 2 | 1.5 | 130 |
| | PO//PP | | | | | | | |
| E19 | PP//LDPE//PP | 190 | <10 | 0.028 | 0.034 | 5 | 3 | 120 |
| E20 | PP//L-LDPE//PP | 120 | <10 | 0.032 | 0.034 | 4 | 1.5 | 120 |
| E21 | PP//Plastomer//PP | 100 | <10 | 0.041 | 0.032 | 3 | 1.3 | 130 |

TABLE 4

| | | Elastic | Size of | Surface- | | | | |
|---|---|---|---|---|---|---|---|---|
| | | modulus in | foreign | Roughness | | | | |
| | Composition & layer | tension | substance | (μm) | | Haze (%) | | Gloss |
| | structure of sheet | (MPa) | (μm) | inner | outer | total | inner | (%) |
| C3 | low-stereoregular PP | 700 | 15 | 0.3 | 0.031 | 10 | 8 | 90 |
| C4 | PP//amorphous | 200 | 18 | 0.081 | 0.081 | 10 | 1 | 95 |
| | PO//PP | | | | | | | |

From Table 3, according to the soft transparent polyolefin resin sheets 11 having the three-layer structure of Experiments 18 to 21, the sheet is made of a soft polyolefin type resin having the aforementioned properties (a) to (c), so that the total haze and the inner haze are lower, resulting in the sufficient transparency. Additionally, the higher gloss effects an appropriate shine.

The producing method according to the present invention allows to produce the soft transparent polyolefin resin sheet 11 having the aforementioned properties (a) to (c).

From Table 4, according to Comparison 3, the resin sheet, which is made by using the same raw materials as in Experiment 18 but by the touch roll sheet forming method, has the average length of the foreign substance and the surface-roughness that exceed the range defined in the present invention, so that the transparency results in low grade by reason of the higher total haze and the higher inner haze. Additionally, it is concluded that the shine is inferior for the lower gloss.

According to Comparison 4, the resin sheet that is made by the touch roll sheet forming method has the average length of the foreign substance and the surface-roughness that exceed the range defined in the present invention, so that the transparency results in being inferior by reason of the higher total haze. Additionally, it is concluded that the shine is dull for the lower gloss.

Experiments 22 to 25

Referring to the third embodiment, the resin sheet 11 is fabricated to change specific examples and the compounding proportions of the raw materials of the sheet, and so on in each experiment as described hereinafter. The resin sheets 11 relating to Experiments 22 to 25 each have a three-layer structure. Table 5 shows the aforementioned properties (a) to (c) which are shown in the resin sheet 11 obtained in each experiment. The specific conditions for producing are the same as in Experiment 1.

The resin used for the middle layer and the outer layers of Experiment 22 is as is the case with Experiment 12.

The resin used for the middle layer and the outer layers of Experiment 23 is as is the case with Experiment 15.

The resin used for the middle layer and the outer layers of Experiment 24 is as is the case with Experiment 16.

The resin used for the middle layer and the outer layers of Experiment 25 is as the case of Experiment 17.

Comparisons 5 and 6

The resin sheet is made by the same manner as the Comparison 1.

The structure of the resin sheet and the composition of resin relating to Comparisons 5 and 6 are the same as that in Comparisons 1 and 2.

Evaluations Concerning Properties

As respects the resin sheets obtained in Experiments 22 to 25 and Comparisons 5 and 6, the average length of the foreign substance, the surface-roughness haze, gloss, and the elastic modulus in tension are measured. The results are shown in Tables 5 and 6.

The number of foreign substances is sighted in a range from 100 to 400 foreign substances in each of Experiments 22 to 25.

The average length of the foreign substance ranges from 1 μm to 5 μm in each of Experiments 22 to 25.

TABLE 5

| | | Elastic | Size of | Surface- | | | | |
|---|---|---|---|---|---|---|---|---|
| | | modulus in | foreign | Roughness | | | | |
| | Composition & layer | tension | substance | (μm) | | Haze (%) | | Gloss |
| | structure of sheet | (MPa) | (μm) | inner | outer | total | inner | (%) |
| E22 | PP//amorphous | 120 | <10 | 0.038 | 0.041 | 2 | 1.5 | 130 |
| | PO//PP | | | | | | | |
| E23 | PP//LDPE//PP | 180 | <10 | 0.032 | 0.027 | 5 | 3 | 120 |
| E24 | PP//L-LDPE//PP | 120 | <10 | 0.033 | 0.035 | 4 | 1.5 | 120 |
| E25 | PP//Plastomer//PP | 100 | <10 | 0.031 | 0.032 | 3 | 1.3 | 130 |

TABLE 6

| | | Elastic | Size of | Surface- | | | |
|---|---|---|---|---|---|---|---|
| | | modulus in | foreign | Roughness | | | |
| | Composition & layer | tension | substance | (μm) | | Haze (%) | |
| | structure of sheet | (MPa) | (μm) | inner | outer | total | inner |
| C5 | low-stereoregular PP | 700 | 15 | 0.35 | 0.031 | 10 | 8 |
| C6 | PP//amorphous | 200 | 18 | 0.091 | 0.09 | 10 | 1 |
| | PO//PP | | | | | | |

From Table 5, according to the soft transparent polyolefin resin sheets 11 having the three-layer structure of Experiments 22 to 25, the sheet is made of a soft polyolefin type resin having the aforementioned properties (a) to (c), so that the total haze and the inner haze are lower, resulting in the decent transparency. Additionally, the higher gloss effects an appropriate shine.

The producing method according to the present invention allows to produce the soft transparent polyolefin resin sheet 11 having the aforementioned properties (a) to (c).

From Table 6, according to Comparison 5, the obtained resin sheet has the higher total haze and the higher inner haze, resulting in the inferior transparency. Additionally, the gloss is low, therefore, naturally the shine is inferior.

According to Comparison 6, the obtained resin sheet has the low grade transparency by reason of the higher total haze. Additionally, the shine is inferior for the lower gloss.

Experiments 26 to 34

Referring to the fourth embodiment, the resin sheet 11 is fabricated by changing specific examples and the compounding proportions of the raw materials of the sheet, and so on in each experiment as described hereinafter. Table 7 shows the aforementioned properties (a) to (c) which are shown in the resin sheet 11 obtained in each experiment. The specific conditions for producing are the same as in Experiment 1.

The resin sheets 11 relating to Experiments 26 to 33 have a single-layer structure.

Soft polypropylene type resin of Experiment 26 . . . a low-stereoregular homo-polypropylene (MI: 3.1 g/10 min., density: 0.90 g/m³, an elastic modulus in tension: 50 MPa, boiled heptane insolubles: 90 wt %). TPO E-2900 (trade name) made by Idemitsu Petrochemical Co., Ltd. The thickness of the sheet . . . 0.2 mm.

Soft polypropylene type resin of Experiment 27 . . . multiple polymerization reactor is used for a compounding process. An ethylene-propylene copolymer (MI: 8.4 g/10 min., density: 0.89 g/cm3, a modulus of elasticity (elastic modulus in tension): 150 MPa), having a form in which a component of an ethylene-propylene rubber (EPR) of approximately 43 wt % is evenly fine-dispersed. CATALLOY KS-082P (trade name) made by HIMONT Inc.

Soft polypropylene type resin of Experiment 28 . . . multiple polymerization reactor is used for a compounding process. An ethylene-propylene copolymer (MI:0.60 g/10 min., density: 0.89 g/cm³, a modulus of elasticity (elastic modulus in tension): 100 MPa), having a form in which a component of EPR of approximately 50 wt % is evenly fine-dispersed. CATALLOY KS-052P (trade name) made by HIMONT Inc.

Soft polypropylene type resin of Experiment 29 . . . an ethylene-propylene random copolymer (Ml: 1.50 g/ 10 min., density: 0.88 g/cm³, an elastic modulus in tension: 100 MPa), in which a soft segment and a hard segment are produced from ethylene of 20 wt % and propylene of 80 wt % by using a single-stage reactor. PER T-310E (trade name) made by TOKUYAMA Corp.

Soft polypropylene type resin of Experiment 30 . . . an ethylene-propylene random copolymer (MI: 1.50 g/10 min., density: 0.88 g/cm³, an elastic modulus in tension: 120 MPa), that is compounded from ethylene of 10 wt % and propylene of 90 wt % as in Experiment 18. PER T-310J (trade name) made by TOKUYAMA Corp.

Soft polypropylene type resin of Experiment 31 . . . a resin composition in which a low-stereoregular homo-polypropylene, as used in Experiment 1, of 70 wt % and a hydrogenated styrene-butadiene rubber (trade name: DYNALON 1320P made by Japan Synthetic Rubber Co., Ltd.) of 30 wt % are blended.

Soft polypropylene type resin of Experiment 32 . . . a resin composition in which a low-stereoregular homo-polypropylene, as used in Experiment 26, of 80 wt % and an ethylene-propylene rubber (EPR) (trade name: TAFMER P0280 made by MITSUI CHEMICAL CO., LTD.) of 20 wt % are blended.

Soft polypropylene type resin of Experiment 33 . . . a resin composition in which a low-stereoregular homo-polypropylene, as used in Experiment 15, of 85 wt % and an ethylene-octene copolymer (trade name: ENGAGE EG-8200 made by DOW CHEMICAL Company) of 15 wt % are blended.

The resin sheet 11 of Experiment 34 has a three-layer structure.

Soft polypropylene type resin used for a middle layer of the sheet of Experiment 34 . . . a resin composition (an elastic modulus in tension: 100 MPa) that is compounded by blending an amorphous polyolefin (density: 0.86 g/cm³, melting viscosity at 190° C.: 10,000 cps) of 50 wt %, compounded by means of a random copolymerization of butene-1 (35 wt %) and propylene (65 wt %), and a crystalline polypropylene (MI: 1.00 g/10 min., density: 0.90 g/cm³) of 50 wt %. CAP-355 (trade name) made by UBE REXSEN CO., LTD. The thickness . . . 160 μm.

Resin used for the outer layers of the sheet of Experiment 34 . . . a hard polypropylene type resin. F-704NP (trade name) made by Idemitsu Petrochemical Co., Ltd. The thickness of each outer layer . . . 20 μm.

Comparisons 7 and 8

The resin sheet is made by the same manner as the Comparison 1

The structure of the resin sheet and the composition of resin relating to Comparisons 7 and 8 are the same as that in Comparisons 1 and 2.

Evaluations Concerning Properties

The resin sheets that are obtained in Experiments 26 to 34 and Comparisons 7 and 8 are measured as to the haze (the total haze/the inner haze), the gloss, and the elastic modulus in tension. The results are shown in Tables 7 and 8.

The number of foreign substances is sighted in a range from 100 to 400 foreign substances in each of Experiments 26 to 34.

The average length of the foreign substance ranges from 1 μm to 5 μm in each of Experiments 26 to 34.

TABLE 7

| | | | | Elastic |
|---|---|---|---|---|
| | Composition & layer | Haze | Gloss | modulus |
| | structure of sheet | (%) | (%) | (MPa) |
| E26 | low-stereoregular PP | 2.5/1.5 | 135 | 500 |
| E27 | EPR fine-dispersion E-P copolymer | 6.0/3.0 | 110 | 150 |
| E28 | EPR fine-dispersion E-P copolymer | 5.0/2.0 | 100 | 100 |
| E29 | E-P random copolymer | 5.0/2.5 | 110 | 100 |
| E30 | E-P random copolymer | 3.0/1.5 | 120 | 120 |
| E31 | low-stereoregular PP/hydrogenated | 2.0/1.0 | 120 | 150 |
| | SBR | | | |
| E32 | low-stereoregular PP/EPR | 3.5/1.5 | 130 | 450 |
| E33 | low-stereoregular PP/E-Oc | 2.0/1.5 | 130 | 400 |
| E34 | PP//amorphous PO//PP | 1.0/0.2 | 130 | 120 |

E26 to E34 are Experiments 26 to 34.
PP is polypropylene.
EPR is ethylene-propylene rubber.
E-P is ethylene-propylene.
PO is polyolefin.
SBR is styrene-butadiene.
E-Oc is a ethylene-octene copolymer.

TABLE 8

| | | | | Elastic |
|---|---|---|---|---|
| | Composition & layer | Haze | Gloss | modulus |
| | structure of sheet | (%) | (%) | (MPa) |
| C7 | low-stereoregular PP | 10.0/7.0 | 100 | 500 |
| C8 | PP//amorphous PO//PP | 8.0/4.0 | 100 | 120 |

C7 and C8 are Comparisons 7 and 8.

From Table 7, according to Experiments 26 to 30, it is concluded that the resin sheet 11, extruded from an extruder by using a soft polypropylene type resin as the materials, is cooled in the producing apparatus, so that the obtained resin sheet 11 has the lower total haze and the lower inner haze, resulting in the appreciable transparency. The high gloss effects the sufficient shine. In addition, the elastic modulus in tension is low, resulting in the sheet wealthy in flexibility.

According to Experiment 31, it is concluded that the resin sheet is similarly made by using the resin composition consisting of a soft polypropylene type resin and a hydrogenated SBR as materials, so that the obtained resin sheet 11 has the low haze and the high gloss.

According to Experiment 32, it is concluded that the resin sheet is similarly made by using the resin composition consisting of a soft polypropylene type resin and an ethylene-αolefin copolymer as materials, so that the obtained resin sheet 11 has the low haze and the high gloss. The elastic modulus in tension is low and the flexibility is effective.

According to Experiment 33, it is concluded that the resin sheet is similarly made by using the resin composition consisting of a soft polypropylene type resin and an ethylene-octene copolymer as materials, so that the obtained resin sheet 11 has the low haze and the high gloss. The modulus of elasticity is low and the flexibility is sufficient.

According to Experiment 34, even in the three-layer structure having both the outer layers of the sheet that is made of a soft polypropylene type resin, the haze, the gloss and the modulus of elasticity are approximately ensured.

From Table 8, according to Comparison 7, the same materials as that in Experiment 1 is used but the resin sheet is made by the touch roll sheet forming method, so that the total haze and the inner haze of the obtained resin sheet are high, thereby being the substandard transparency. The shine results in being less than adequate by reason of the low gloss.

According to Comparison 8, the resin sheet is made by the touch roll sheet forming method, so that the obtained resin sheet has the high total haze, resulting in the inferior transparency.

Experiment 35

Referring to the fifth embodiment, the following are the specific conditions in the producing method.

Diameter of the extruder . . . 90 mm, the width of the T-die . . . 800 mm.

Materials of the elastic member . . . silicone rubber, the thickness . . . 10 mm, the hardness . . . 30 degrees.

Processing speed of the sheet . . . 16 m/min.

Surface temperature of the roller and the endless belt that is on contact with the sheet . . . 15° C.

Polypropylene type thermoplastic elastomer . . . IDEMITSU TPO E-2900 (trade name, made by Idemitsu Petrochemical Co., Ltd.), 85 wt %.

Ethylene-vinyl acetate copolymer resin . . . ULTRATHEN 630 (trade name, TOHSO Corporation), 15 wt %.

Thickness of the resin sheet . . . 0.2 mm.

Experiments 36 and 37

In the producing method of Experiment 35, the resin sheet 11 is fabricated by changing the compounding proportions of the materials of the sheet as described below. The conditions for producing are as in the case of Experiment 1.

More specifically, the compounding proportion in Experiment 36 is the above elastomer of 70 wt %, and the above copolymer resin of 30 wt %. In

Experiment 37, the above elastomer is 95 wt % and the above copolymer resin is 5 wt %.

Experiments 38 to 40

In the producing method of Experiment 35, the resin sheet 11 is fabricated by changing the specific examples and the compounding proportions of the raw materials of the sheet as described below.

Here, ULTRATHEN 631 (trade name, made by TOHSO Corporation) issued as a copolymer resin. In Experiment 38, the elastomer is 85 wt %, and the copolymer resin is 15 wt %.

In Experiment 39, the elastomer is 70 wt %, and the copolymer resin is 30 wt %. In Experiment 40, the elastomer is 95 wt %, and the copolymer resin is 5 wt %.

Experiments 41 to 43

In producing method of Experiment 35, the resin sheet 11 is fabricated by changing the specific examples and the compounding proportions of the raw materials of the sheet as described below.

Here, ULTRATHEN 634 (trade name) is used as a copolymer resin. In Experiment 41, the elastomer is 85 wt %, and the copolymer resin is 15 wt %.

In Experiment 42, the elastomer is 70 wt %, and the copolymer resin is 30 wt %. In Experiment 43, the elastomer is 95 wt %, and the copolymer resin is 5 wt %.

Experiments 44 to 46

Concerning the producing conditions, the hardness of the elastic member is change into 60 degrees from the value of Experiment 35. The other conditions for producing are the same as in Experiment 35. The materials of the sheet which are used here are described below.

In Experiment 44, the raw materials of the sheet are the same as in Experiment 35.

In Experiment 45, the raw materials of the sheet are the same as in Experiment 38.

In Experiment 46, the raw materials of the sheet are the same as in Experiment 41.

Comparisons 9 to 13

In Comparisons 9 and 10, the resin sheet is fabricated by the conventional touch roll sheet forming method in which a cooling roller is used. The temperature of the cooling roller is 30° C.

In Comparison 9, ULTRATHEN 634 (trade name) is used instead of the copolymer resin used in Experiment 50. The elastomer is 70 wt %, and the copolymer resin is 30 wt %.

In Comparison 10, IDEMITSU PP F-205S (trade name) as polypropylene is used instead of the elastomer. EG-8200 (trade name, made by DOW CHEMICAL Company) as an ethylene-octene-1 copolymer is used instead of the copolymer resin. IDEMITSU PP F-205S is 90 wt %. EG-8200 is 10 wt %.

In Comparisons 11 and 12, the resin sheet 11 is fabricated as the case of Experiment 1, but the compounding proportions of the materials of the sheet is changed as follows.

In Comparison 11, the elastomer is 97 wt % and the copolymer resin is 3 wt %. In Comparison 12, the elastomer is 60 wt % and the copolymer resin is 40 wt %.

In Comparison 13, the hardness of the elastic member in the conditions for producing is changed to 100 degrees from the value of Experiment 35. The other conditions for producing and the materials of the sheet are the same as in Experiment 35.

Evaluations Concerning Properties

The resin sheets that are obtained in the aforementioned Experiments and Comparisons are measured as to haze (cloudiness), gloss (shine), and a power loss factor (a dielectric loss tangent) tanδ. The results are shown in Tables 10 and 11.

The haze is measured in conformity with ASTM D1003.

The gloss is measured in conformity with ASTM D2457.

The tanδ is measured at 1 MHz.

TABLE 10

| | Materials & compounding property | Haze | Gloss | |
|---|---|---|---|---|
| | (wt %) | (%) | (%) | tanδ |
| E35 | E-2900 (85)/Ultrathen 630 (15) | 2.5 | 135 | 6.0 × 10⁻³ |
| E36 | E-2900 (70)/Ultrathen 630 (30) | 3.0 | 135 | 8.0 × 10⁻³ |
| E37 | E-2900 (95)/Ultrathen 630 (5) | 2.5 | 135 | 4.0 × 10⁻³ |
| E38 | E-2900 (85)/Ultrathen 631 (15) | 3.0 | 135 | 8.0 × 10⁻³ |
| E39 | E-2900 (70)/Ultrathen 631 (30) | 3.0 | 130 | 1.0 × 10⁻² |
| E40 | E-2900 (95)/Ultrathen 631 (5) | 2.5 | 135 | 6.0 × 10⁻³ |
| E41 | E-2900 (85)/Ultrathen 634 (15) | 3.5 | 130 | 1.0 × 10⁻² |
| E42 | E-2900 (70)/Ultrathen 634 (30) | 5.0 | 130 | 2.0 × 10⁻² |
| E43 | E-2900 (95)/Ultrathen 634 (5) | 3.0 | 135 | 8.0 × 10⁻³ |
| E44 | E-2900 (85)/Ultrathen 630 (15) | 2.5 | 135 | 6.0 × 10⁻³ |
| E45 | E-2900 (85)/Ultrathen 631 (15) | 3.0 | 135 | 8.0 × 10⁻³ |
| E46 | E-2900 (85)/Ultrathen 634 (15) | 3.5 | 130 | 1.0 × 10⁻² |

TABLE 11

| | Materials & compounding property | Haze | Gloss | |
|---|---|---|---|---|
| | (wt %) | (%) | (%) | tanδ |
| C9 | E-2900 (70)/Ultrathen 634 (30) | 10.0 | 80 | 2.0 × 10⁻² |
| C10 | F-205S (90)/EG-8200 (10) | 15.0 | 95 | 1.0 × 10⁻³ |
| C11 | E-2900 (97)/Ultrathen 630 (3) | 2.5 | 135 | 1.0 × 10⁻³ |
| C12 | E-2900 (60)/Ultrathen 630 (40) | 10.0 | 100 | 1.0 × 10⁻² |
| C13 | E-2900 (85)/Ultrathen 630 (15) | | | |

From Table 10, according to Embodiments 35 to 46, it is concluded that the resin sheet 11, which is extruded from the extruder by using a polypropylene type thermoplastic elastomer and an ethylene-vinyl acetate copolymer resin (5 wt % to 30 wt %) as the raw materials, is cooled in the producing apparatus, so that the obtained resin sheet 11 has the adequate transparency by reason of the low haze and the effective shine by reason of the high gloss.

Additionally, a polypropylene type thermoplastic elastomer is contained, so that the power loss factor is large, thereby improving the ability of the high-frequency heating.

From Table 11, according to Comparison 9, the resin sheet is fabricated by using the same materials as in Experiments, but by the touch roll sheet forming method, so that the obtained resin sheet has the inferior transparency by reason of the high haze and the substandard shine by reason of the low gloss.

According to Comparison 10, the resin sheet is fabricated by the touch roll sheet forming method, so that the high haze in the obtained resin sheet causes the transparency to be low-grade and the low gloss causes the shine to be dull. Additionally, a polypropylene type thermoplastic elastomer is not used for the sheet, so that the power loss factor is extremely low, thereby little providing effective in the high-frequency heating.

According to Comparison 11, the content of an ethylene-vinyl acetate copolymer resin is below the range relating to the present invention so that the power loss factor is extremely low, thereby providing little effective high-frequency heating.

According to Comparison 12, the content of an ethylene-vinyl acetate copolymer resin exceeds the range relating to the present invention, so that the haze is high and the transparency results being substandard, additionally the gloss is low and the shine is inferior.

In Comparison 13, the hardness of the elastic member exceeds the range defined for the present invention, so that the elastic force is low. Therefore, resin banks are produced when the resin sheet is cooled, with the result that the sheet having a smooth and high-quality appearance cannot be obtained.

What is claimed is:

1. A soft transparent polyolefin resin sheet having a multilayered structure wherein at least one surface layer is made of a hard polypropylene type resin and at least one other layer is made of a soft resin, the polyolefin resin sheet having the following properties:
(a) a modulus of elasticity from 20 MPa to 1,000 MPa;
(b) an average length of a foreign substance that has a refractive index different from a non-crystalline resin composition occupying the most volume fraction being less than 10 μm, and the number of foreign substances in any section of the sheet being less than 500 foreign substances/mm²; and
(c) less than 0.2 μm of surface-roughness Ra of the at least one surface layer.

2. The soft transparent polyolefin resin sheet according to claim 1, said multilayered structure having at least three layers including both the surface layers and an intermediate layer, said surface layers being composed of said hard polypropylene type resin, and said intermediate layer being composed of said soft transparent polyolefin resin.

3. The soft transparent polyolefin resin sheet according to claim 1, wherein the modulus of elasticity under tension of the sheet is 50 to 800 MPa.

4. The soft transparent polyolefin resin sheet according to claim 1, wherein said surface layer is made of a resin selected from a group consisting of: homo-polypropylene, ethylene-propylene random copolymer (ethylene content ranging from 0.1 wt % to 10 wt %), and ethylene-butene-propylene random copolymer (ethylene and butene content ranging from 0.1 wt % to 10 wt %).

5. The soft transparent polyolefin resin sheet according to claim 2, wherein said surface layer is made of a resin selected from homo-polypropylene ethylene-propylene random copolymer (ethylene content ranging from 0.1 wt % to 10 wt %), and ethylene-butene-propylene random copolymer (ethylene and butene content ranging from 0.1 wt % to 10 wt %).

6. The soft transparent polyolefin resin sheet according to claim 1, wherein said soft transparent polyolefin resin is a low-stereoregular polypropylene type resin having a ratio of mmm-m (a value of PI) ranging from 50% to 90% in a pentad ratio measured by using ¹³ C-NMR with respect to stereoregularity of homo-polypropylene.

7. The soft transparent polyolefin resin sheet according to claim 6, wherein a value of rrrr/(1-mmmm) of said low-stereoregular polypropylene type resin ranges from 15% to 50%.

8. The soft transparent polyolefin resin sheet according to claim 6, wherein said low-stereoregular polypropylene type resin consists of a boiled heptane insoluble polypropylene type resin (from 50 wt % to 95 wt %) having the limiting viscosity ranging from by [η]0.5 dl/g to [η]9.0 dl/g, and a boiled heptane soluble polypropylene type resin (from 5 wt % to 50 wt %) having the limiting viscosity of more than [η]1.2 dl/g.

9. The soft transparent polyolefin resin sheet according to claim 1, wherein said soft transparent polyolefin resin is an ethylene-propylene random copolymer (ethylene content ranging from 5 wt % to 30 wt %).

10. The soft transparent polyolefin resin sheet according to claim 9, wherein the proportion of ethylene-propylene random copolymer in a unit PPEP composed or continued four elements of ethylene (E) and propylene (P) has a racemic configuration for a continued part of PP that is extremely small.

11. The soft transparent polyolefin resin sheet according to claim 1, wherein said soft transparent polyolefin resin is a non-crystalline butene-1-propylene copolymer.

12. The soft transparent polyolefin resin sheet according to claim 1, wherein said soft transparent polyolefin resin is a compound of a non-crystalline butene-1-propylene copolymer and polypropylene.

13. The soft transparent polyolefin resin sheet according to claim 1, wherein said soft transparent polyolefin resin is a propylene-ethylene-butene-1 copolymer.

14. The soft transparent polyolefin resin sheet according to claim 1, wherein said soft transparent polyolefin-resin is a compound of a propylene-ethylene-butene-1 copolymer and polypropylene.

15. The soft transparent polyolefin resin sheet according to claim 1, wherein said soft transparent polyolefin resin contains a reactor blending type ethylene-propylene copolymer elastomer.

16. The soft transparent polyolefin resin sheet according to claim 1, wherein said soft transparent polyolefin resin contains a reactor blending type ethylene-propylene-butene-1 copolymer.

17. The soft transparent polyolefin resin sheet according to claim 1, wherein said soft transparent polyolefin resin is selected from at least one of an ethylene monopolymer and an ethylene-a-olefin copolymer.

18. The soft transparent polyolefin resin sheet according to claim 17, wherein said ethylene monopolymer is at least one selected from a high-pressure-produced low-density polyethylene and a low-pressure-produced low-density polyethylene.

19. The soft transparent polyolefin resin sheet according to claim 17, wherein said ethylene-α-olefin copolymer is at least one selected from a group consisting of: Ziegler-Natta catalyst type linear low-density polyethylene, a metallocene catalyst type linear low-density polyethylene, and an ethylene-octene copolymer having long branching in a main chain polymerized by using constrained geometry catalyst technology.

20. The soft transparent polyolefin resin sheet according to claim 1, wherein the soft transparent polyolefin resin is composed of a soft polypropylene type resin.

21. The soft transparent polyolefin resin sheet according to claim 20, wherein 2 wt % to 30 wt % of hydrogenated styrene-butadiene rubber is mixed into said soft transparent polyolefin resin.

22. The soft transparent polyolefin resin sheet according to claim 20, wherein 2 wt % to 30 wt % of an ethylene-α-olefin copolymer is mixed into said soft transparent polyolefin resin.

23. The soft transparent polyolefin resin sheet according to claim 20, wherein 2 wt % to 30 wt % of an ethylene-octene copolymer is mixed into said soft transparent polyolefin resin.

24. The soft transparent polyolefin resin sheet according to claim 1, the soft transparent polyolefin resin comprising:
a polypropylene type thermoplastic elastomer; and
an ethylene-vinyl acetate copolymer resin.

25. The soft transparent polyolefin resin sheet according to claim 24, wherein the content of said ethylene-vinyl acetate copolymer resin ranges from 5 wt % to 30 wt %.
